(19) United States
(12) Patent Application Publication
(10) Pub. No.: US 2019/0347734 A1
(43) Pub. Date: Nov. 14, 2019

(54) NETWORKED SYSTEM IMPLEMENTATION OF A NEW INDEX THROUGH GENERATING, REBALANCING, AND SETTLING PROCESSES

(71) Applicants: MARKIT INDICES GMBH, Frankfurt Am Main (DE); BLACKROCK, INC., San Francisco, CA (US); CBOE EXCHANGE, INC., Chicago, IL (US)

(72) Inventors: ARAM FLORES, NEW YORK, NY (US); YI ZHANG, NEW YORK, NY (US); FRANS SCHEEPERS, NEW YORK, NY (US); MARTIN SMALL, NEW YORK, NY (US); JAMES J. HILL, NEW CANAAN, CT (US); STEPHEN LAIPPLY, SAN FRANCISCO, CA (US); SAMARA E. COHEN, NEW YORK, NY (US); DENNIS O'CALLAHAN, EVANSTON, IL (US); JOHN DETERS, CHICAGO, IL (US)

(21) Appl. No.: 16/407,917

(22) Filed: May 9, 2019

Related U.S. Application Data
(60) Provisional application No. 62/669,873, filed on May 10, 2018.

(51) Int. Cl. G06Q 40/06; G06Q 40/04; G06F 16/13; G06F 16/18

(52) U.S. Cl. CPC G06Q 40/06; G06F 16/1865; G06F 16/13; G06Q 40/04

(57) ABSTRACT

A system and method of creating and managing a new index or index fund for investors. The new index is created by cross referencing the holdings information of an exchange-traded fund (ETF). The ETF has the constituents or index holdings information of a benchmark index or a liquid subset of the benchmark index, either of which may be thought of as an initial benchmark index. The initial benchmark index is passively tracked by the ETF. In some implementations of systems providing the new index, futures contracts and/or options on futures contracts are settled by reference to the index levels of the new index, and these futures contracts and/or options may be labeled exchange-traded derivatives.

### CROSS REFERENCE TO RELATED APPLICATION

This application claims priority to U.S. Provisional Patent Appl. No. 62/669,873, filed on May 10, 2018, which is incorporated herein in its entirety.

### BACKGROUND

### 1. Field of the Invention

The present description generally relates to systems and methods of generating and updating or managing financial instruments including benchmark indices, index funds, exchange-traded funds (ETFs), and futures. More particularly, the present description relates to computer network or networked system operating to generate a new index (or index fund) through new and practical applications of generating and rebalancing the new index and of settling exchange traded derivatives using the new index.

### 2. Relevant Background

The financial industry continues to demand new products to provide its customers including new index funds. Several technical issues, however, have made creation and management of these funds difficult including how best to algorithmically process large amounts of market-based information that is available over computer networks, often in real time. This processing includes the challenge of which market products to include in an index fund and how best to rebalance the index fund utilizing market information tracked via computer systems and tracking software.

An index fund is a mutual fund or exchange-traded fund (ETF) designed to follow certain preset rules so that the fund can track a specified group of investments or market products. Historically, the preset rules may include tracking prominent indexes like the Standard & Poors (S&P) 500 or the Dow Jones Industrial Average or may include implementation rules such as tax management or screening for social and sustainable criteria. An index fund's rules of construction (or preset rules) typically identify the type of companies or investments suitable for the fund such as those available in a particular geographic area, associated with companies or investments of a particular size, and/or corresponding with a level of risk or volatility.

Index funds allow consumers to participate in rules-based investing, and such funds have proven very popular with index funds making up more than twenty percent of the equity mutual fund assets in the United States. Index funds usually have lower fees and do not require a lot of time to manage as the investors do not have to spend time analyzing specific market products or investments. Hence, there remains a strong demand for new index funds that provide the advantages of existing index funds but present investors with new investment opportunities.

Investment mandates restrict firms such as pension funds and asset managers from trading equities or OTC derivatives. These restrictions make it increasingly difficult to gain exposure to asset classes without approved financial products available on regulated exchanges. With the proper construction of a new index for a financial product to reference, these mandate-restricted investors can gain near exact exposure to what is offered to investors trading its exchange-traded fund counterpart.

### SUMMARY

With the above demands and technical challenges in mind, the inventors created a method of creating and managing a new index (or a new index fund) along with a system for providing a practical application of or implementing the new index for use by investors (or customers). The new index is created by cross referencing the holdings information of an exchange-traded fund (ETF), and the holdings information may therefore be labeled “ETF holdings information.” The ETF has the constituents (or “index holdings information”) of a benchmark index or a liquid subset of the benchmark index (which may be thought of as an “initial benchmark index”). The initial benchmark index is tracked by the ETF, e.g., passively tracked. In some implementations of systems providing the new index, futures contracts and/or options on futures contracts are settled by reference to the index levels of the new index, and these futures contracts and/or options may be labeled “exchange-traded derivatives” (or ETDs).

More particularly, in one practical application of the new index method, a system is provided for creating and managing a new index. The system includes a first server and a first computer (or computing device) executing code (e.g., one or more software modules or routines) to provide an index provider. During system operations, the index provider creates an initial benchmark index and generates a benchmark index file stored on the first server that defines a set of investment constituents and index levels for each of the investment constituents. The system also includes a second server and a second computer executing code to provide an exchange-traded fund (ETF) provider. The ETF provider creates an ETF to track the initial benchmark index and generates an ETF holdings file stored on the second server that defines a set of holdings of the ETF and index levels for each of the holdings. The holdings include a subset of the set of the investment constituents of the initial benchmark index. During system operations, the index provider creates a new index by cross referencing the initial benchmark index and the ETF and generates a new index file defining holdings of the new index and index levels for each of the holdings of the new index.

In some implementations of the system, the index provider periodically publishes the new index file via a server to an exchange, and the exchange provides trading of an exchange-traded derivative or future that is settled by the exchange by reference to the index levels of the new index. In the same or other implementations of the system, the cross referencing comprises weighting any constituents held in common between holdings information for the ETF and the initial benchmark index. The weighting may be performed using a notional amount in the ETF subject to constraints to keep composition of the new index within risk parameter boundaries for the initial benchmark index.

In some embodiments of the system, the index provider rebalances the new index monthly on the first business day of a new month with the holdings of the new index being investments present in both the holdings of the ETF and the investment constituents of the initial benchmark index on the last business day of the month prior to the new month. In the same or other embodiments, the investment constituents in the benchmark index file are selected by the index provider from a corporate bond database based on a set of constituent criteria, whereby the initial benchmark index provides broad coverage and performance attributes of high yield corporate debt from developed countries. For example, the index provider may rebalance the initial benchmark index monthly on a rebalancing date using the set of constituent criteria to perform a query on the corporate bond database so that the set of the investment constituents includes sub-investment grade bonds issued by corporate issuers from developed countries that are rated by at least one rating service. Additionally, the index provider may populate the corporate bond database based on data retrieved from at least one of internal bond reference and pricing data feeds, third party data provider bond feeds, and bond rating feeds.

In some preferred embodiments of the system, the investment constituents include bonds, and the index provider creates a liquid subset of the set of investment constituents to define an alternate initial benchmark index for use in place of the initial benchmark index by the ETF provider and in the cross referencing to generate the new index. Further, the creating of the liquid subset includes selecting the investment constituents with a face value greater than a minimum outstanding face value criteria used by the index provider in selecting the investment constituents for the initial benchmark index. In these or other embodiments, the ETF provider may create the ETF using representative index sampling on the initial benchmark index, and the holdings of the ETF may include at least 80 percent (with some providing a concentration of more than 90 percent) of total assets the ETF in a particular industry or group of industries to an extent matching that of the initial benchmark index.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a flow diagram or data flow schematic for a method of managing a new index of the present description, including creating and updating the new index and settling investments in the new index, as may be practically implemented with a particular arrangement of networked computing and data storage devices; and

FIG. 2 illustrates a functional block diagram of an index management or provision system of the present description showing technical workflow and/or data flow during operation of the index management or provision system to carry out the steps described with reference to FIG. 1.

### DETAILED DESCRIPTION

Briefly, the present description presents a system of networked computers or computing and/or data storage devices configured specially to implement a new index (or, interchangeably, a new index fund). The new index is created in part by cross-referencing holdings information of an exchange-traded fund (ETF), and the holdings information may therefore be labeled “ETF holdings information.” The ETF has the constituents or index holdings information of a benchmark index or a liquid subset of the benchmark index, either of which may be thought of as an “initial benchmark index.” The initial benchmark index is tracked by the ETF, e.g., passively tracked. In some implementations of systems providing the new index, futures contracts and/or options on futures contracts are settled by reference to the index levels of the new index, and these futures contracts and/or options may be labeled “exchange-traded derivatives” (or ETDs).

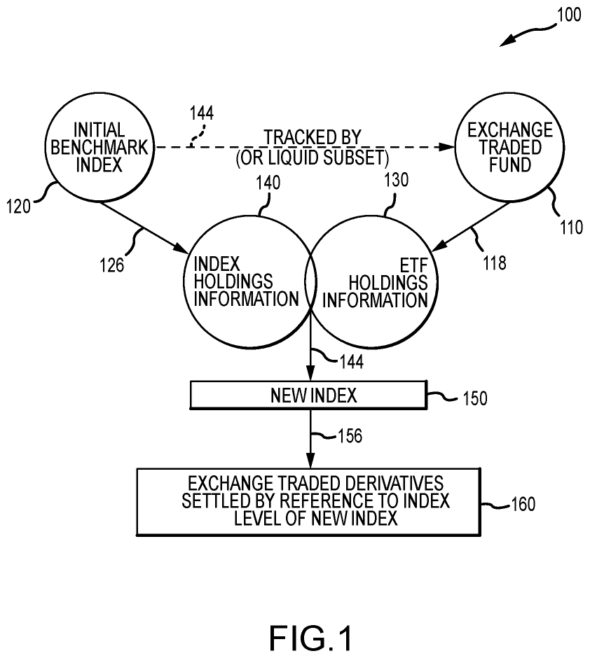

FIG. 1 is a flow diagram or data flow schematic for a method 100 of managing a new index of the present description. In general, the method 100 includes creating and updating the new index and settling investments in the new index, and the method 100 may be practically implemented with (or a practical application may be provided by) an arrangement/system of networked computing and data storage devices as described with reference to later figures. A first step of the index management method 100 is the creation of an initial benchmark index 120. The initial benchmark index is created, e.g., through software running on one or more computers with access over a digital communications network to one or more financial markets (or data storage servers or other devices of such a market). The initial benchmark index is designed (through the underlying algorithms of the software) to accurately track the performance of a specific segment of a market. In some preferred implementations of the method 100, the software used to create the initial benchmark index 120 is adapted to utilize a standardized approach for constituent selection from the market(s).

A second step of the method 100 is the creation of an ETF 110 again with software running on one or more computing devices communicatively linked to the market data storage servers or device and/or to a computing device used to create the initial benchmark index 120. The ETF 110 is adapted to passively track, as shown with dashed line 114 in FIG. 1, the initial benchmark index 120. Due to optimization through representative index sampling applied by a portfolio manager of the ETF 110, the ETF holdings information 130 (tracked/obtained and stored in memory or data storage of a system implementing the new index as shown with arrow 118) may differ from the index holdings information 140 (tracked/obtained and stored in memory or data storage of the system implementing the new index as shown with arrow 126).

Hence, a third step of the method 100 (which may be carried out by an index-creation and management module run on a computing device) is to cross-reference the ETF holdings information 130 with the index holding information 140 to create the new index 150 as shown by overlap of information 130 and 140 and with arrow 144. During this cross-referencing in one exemplary implementation of the method 100, any constituents held in common between the ETF holdings information 130 and the index holdings information 140 are weighted. In one case, these identified common constituents are weighted using the notional amount in the portfolio in the ETF 110. Further, in this case or other implementations, this weighting may be performed (e.g., by a weighting submodule of the index-creation module) subject to constraints to keep the composition in the new index within certain risk parameter boundaries defined for the initial benchmark index 120.

Additionally, the step of creating (or managing/updating) the new index may include removal of certain investments (such as bonds or equities) followed by substitution of another investment (such as bonds) in the ETF holdings information 130. The removal and, in some cases, substitution is performed to keep the composition of the constituents of the new index 150 with predefined risk parameter boundaries (e.g., of the initial benchmark index 120). The method 100 may include rebalancing the new index using a predefined time period (such as daily, weekly, or some other useful time period with one proposed embodiment rebalancing the new index monthly).

A fourth step, as shown with arrow 156 and box 160 of FIG. 1, is the settling of exchange-traded derivatives (ETDs) by reference to index levels of the new index 150. For the ETD to be “exchange traded,” the method 100 includes trading each ETD all-to-all on a trading venue. Further, the method 100 is typically performed so that trading of the ETD may include anonymous all-to-all trading on a central limit order book.

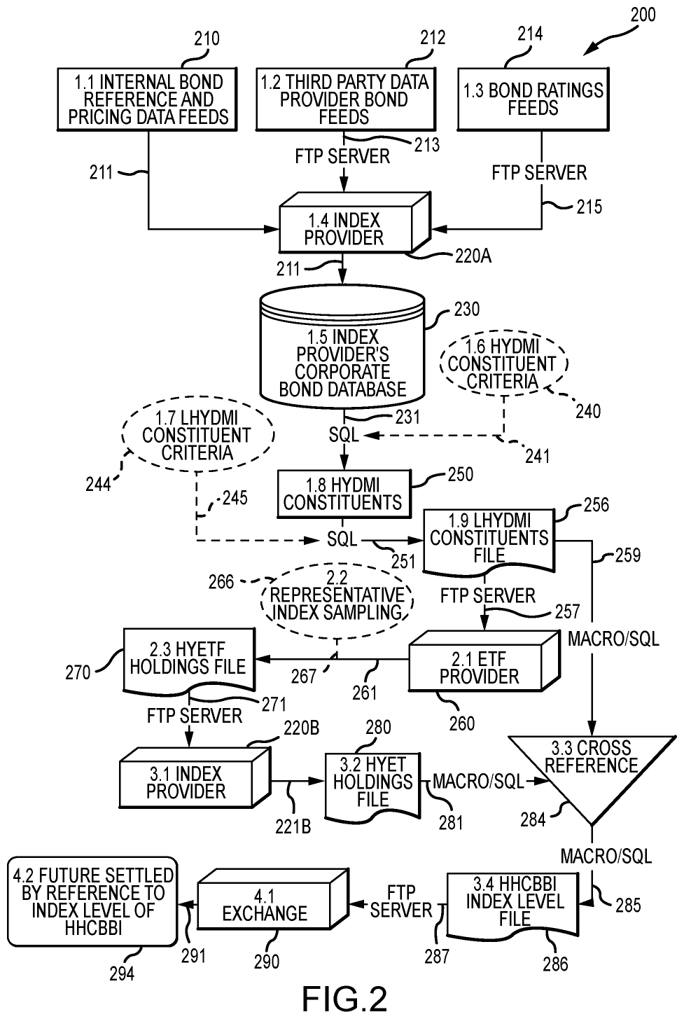

FIG. 2 is a functional block diagram of an index management or provision system 200 of the present description showing technical workflow and/or data flow during operation of the index management or provision system 200 to carry out the steps described with reference to FIG. 1. Generally, the system 200 is made up of networked components (or communicatively linked computing systems/devices) that share data and act on this data to create and manage a new index of the present description.

As shown, for example, the system 200 includes an index provider computer system or device (or simply a “system provider”) 220 (shown at operating states 220A and 220B) running software with a processor(s) to provide the index creation and management functions discussed herein (including rebalancing the index and cross-referencing processes). The index provider 220 is communicatively linked to one or more servers (e.g., FTP servers) to obtain data feeds, and is further communicatively linked to a storage device/memory device storing and managing a database (as shown at 230) and storing other information useful for creating and managing the new index including index constituent files, constituent criteria, and holdings files (as shown at 240, 244, 250, 256, 270, 280) and the like.

Additionally, the system 200 includes an ETF provider in communication with the index provider such as via an FTP or other server as shown at 271 in FIG. 2. The ETF server may also be in communication with the storage device storing the database 230 such as via an FTP server or the like (as shown at 257 in FIG. 2). The index provider 220 is also communicatively linked or networked with an exchange computer system/device (or simply an “exchange”) such as via an FTP server as shown at 287 in FIG. 2 to facilitate settling of futures using the new index.

With the practical application of the networked system 200 for providing an index understood, it may now be useful to refer to FIG. 2 to provide further explanation of each of the four steps of creating and managing the new index previously discussed above with reference to FIG. 1. As a first step (with reference to system 200 components with labeled 1.1-1.9), an initial benchmark index is created to accurately track the performance of a specific segment of a market with a standardized approach for constituent selection for a new index. For the purposes explanation and illustration of the components and operations of the system 200, an exemplary (but not limiting of the invention) high yield developed markets index (“HYDMI”) may be used as one practical application or implementation of one useful initial benchmark index for use in creating a new index. The HYDMI may, in some preferred cases, be designed to offer broad coverage and performance attribution of United States Dollar (USD) denominated high yield corporate debt from developed countries, but other implementations of the system 200 may use a different initial benchmark index to track a different segment of a market.

The HYDMI is rebalanced periodically by the index provider 220A such as once a month (e.g., at month's end) on a “rebalancing date.” The HYDMI, in this example operation of system 200, may have as its constituents, matching the criteria 240 and stored in a listing of constituents 250 in memory/data storage accessible by the index provider 220A, sub-investment grade USD-denominated bonds that may be issued by corporate issuers from developed countries and rated by one or more rating services (e.g., Fitch Ratings, Moody's Investors Service, S&P Global Ratings, and the like). The bonds/constituents 250 are chosen as meeting all the criteria set forth in the index rules as may be defined by the criteria 240 and stored in memory/data storage accessible by the index provider as shown at 241 (such as index rules as of the close of business three business days prior to the rebalancing date).

To arrive at the constituency (or HYDMI constituents) 250, the index provider 220A (e.g., an index creation module running on a computing device) executes a query (e.g., an SQL query or the like) on the index provider's corporate bond database 230 as shown at 231 and using the HYDMI constituent criteria 240 as shown at 241. The computing device providing the index provider 220A is communicatively linked or networked to one or more data storage devices and/or memory storing the database 230. The database 230 is populated as shown with arrow 221 by the index provider 220A via one or more internal reference and pricing data feeds 210 as shown at 211, third party data provider bond feeds 212 (that may be provided on an FTP server or the like accessible by the index provider 220A) as shown at 213, and/or bond ratings feeds 214 (that may be provided on an FTP server or the like accessible by the index provider 220A) as shown at 215.

Alternatively, a liquid sub-set of the HYDMI 250 may be used as the initial benchmark index as shown in FIG. 2 with the LHYDMI constituents file 256. To create a liquid sub-set of the HYDMI 250, the index provider 220A applies a narrower set of criteria 244 to select bonds that meet specified liquidity criteria 244. This may involve the index provider 220A issuing a query as shown at 251 on the HYDMI constituents 250 (or a database listing of such constituents) as shown at 251 to provide the liquid sub-set shown at 256. Either of these two initial benchmark index files 250 or 256 may be provided in a networked manner to the index provider 220A/220B and the ETF provider 260 such as by providing the indices 250, 256 on a server (e.g., an FPT server as shown at 257 and/or for SQL or other queries as shown at 259).

One major contributing factor to a bond's liquidity is its outstanding face value. The larger a bond's outstanding face value, the more parties can hold it and trade it. Hence, the higher the outstanding face value, the more liquid it will be. By way of illustration, all bonds included in the HYDMI 250 may be required by criteria 240 to have an outstanding face value greater than or equal to some predefined minimum bond face value such as USD 200 mm. Therefore, selecting bonds from the HYDMI universe (i.e., from HYDMI constituents 250) that have a greater face value than this predefined minimum value such as at a second predefined minimum bond face value (or at some factor or percentage above the first predefined minimum bond face value) will create a liquid portion of this index as shown at 256. In the present example, the criteria 244 may require the bond to have a face value of USD 400 mm to provide a liquid portion of the index defined by HYDMI constituents 250.

To arrive at this liquid composition, the index provider 220A executes an additional SQL or other query 251 containing the narrower criteria 244 on the database 230. In some cases, the LHYDMI constituents and index levels are exported to a deliverable file as shown at 256 and published periodically (e.g., daily) such as via an FTP server or the like. A similar process would be followed if the HYDMI were used as the initial benchmark index in system 200.

Now, turning to the second step of the new index creating and management process, the system 200 shows with components labeled 2.1-2.3 workflow that provides creation of an ETF that passively tracks the initial benchmark index (defined by HYDMI constituents 250 or by LHYDMI constituents 256). An ETF is created by an ETF provider 260 (e.g., an ETF module or software suite running on one or more computing devices communicatively coupled to the FTP server as shown at 257). The ETF passively tracks the initial benchmark index. The ETF holdings information in file 270 is generated by the ETF provider 260 as shown at 261 based on representative index sampling 266 as shown at 267. Due to optimization through representative index sampling applied by the portfolio fund manager of the ETF or operator of the ETF provider 260, the ETF holdings information in file 270 may differ from the index holdings information.

“Representative index sampling” by the ETF provider 260 involves testing in a representative sample of securities that collectively have an investment profile like that of an applicable underlying index. The ETF may or may not hold all the securities in the reference initial benchmark index and may also hold additional securities that are not in the initial benchmark index. For the purposes of this explanation and by way of illustration, the portfolio fund manager/ETF provider 260 of the high yield ETF defined by the holdings file 270 implements an investment strategy to passively track the LHYDMI (but could use the HYDMI in other implementations). The ETF provider 260 downloads the daily constituents and index levels of the LHYDMI from the index provider 220A such as via an FTP server as shown at 257. The portfolio fund manager/ETF provider 260 then uses a representative index sampling strategy 266 as shown with arrow 267 to manage as shown with arrow 261 the HYETF defined in holdings file 270.

The HYETF is designed to track the LHYDMI and may or may not hold all the securities in the LHYDMI. The HYETF concentrates its investments (e.g., holds 25 percent or more of its total assets) in a particular industry or group of industries to approximately the same extent that the LHYDMI is concentrated. The degree to which these components represent certain industries may change over time. The HYETF will generally invest some preset minimum percentage (such as at least 90 percent) of its assets in the component securities of the LHYDMI (or HYDMI in other initial benchmark index cases) and may invest the remaining percentage/fraction (such as up to 10 percent) of its assets in certain futures, options, and swap contracts, cash and cash equivalents (including shares of money market funds advised by an operator of the ETF provider), securities not included in the initial benchmark index but which the operator of the ETF provider 260 believes will help the HYETF track the initial benchmark index, and/or other investments.

Periodically, when conditions warrant, the ETF provider may operate to change these preset minimums/maximum percentages such as to at least 80 percent and up to 20 percent, respectively. In general, the HYETF is configured (through ongoing operations of the ETF provider 260) to track the investment results of the initial benchmark index (e.g., the HYDMI or the LHYDMI) before fees and expenses of the HYETF. The HYETF holdings are made available in a deliverable file 270 for relevant parties and uploaded to an FTP server or the like for download (e.g., as shown at 271 by the index provider 220B).

Now, turning to the third step of the new index creation and management method with reference to components labeled 3.1-3.4 in FIG. 2, an explanation is provided of how cross-referencing of the ETF holdings information with the index holding information is performed to create the new index. The cross referencing step is shown at 284 and is provided by the index provider 220B as shown at 221B using the HYETF holdings file 280 and queries 259 and 281 on this file 280 and the LHYDMI constituents file 256. In the cross reference step 284, any constituents held in common between the ETF holdings information in file 280 and the index holdings information in file 256 are weighted, such as using the notional amount in the exchange traded fund portfolio, subject to constraints to keep the composition within certain risk parameter boundaries of the initial benchmark index. As shown with arrow 285, the index provider 220B creates a file 286 that defines the new index (e.g., with its holdings information/constituents and index levels and labeled a hybrid holdings corporate bond benchmark index (HHCBBI) in this non-limiting example).

In some implementations of system 200, the new index defined in file 286 is rebalanced monthly (but another rebalancing time period may be used to practice the invention). In one practical application of the rebalancing by the index provider 220B, the bonds included in the new index on the first business day of the month are chosen to be the bonds that are held in common in both the initial benchmark index and the portfolio holdings of the ETF as of the last day of the prior month. For the purposes of this explanation and by way of illustration, on the last business day of the month (or another set time and/or date), the index provider 220B will retrieve the HYETF holdings file 270 from an FTP server as shown at 271. The holdings of the HYETF and constituents of the LHYDMI (defined in files 280 and 256, respectively) are cross referenced at 284 using macros and SQL (or other) queries 281 and 259, respectively, to form as shown at 285 the new index defined in file 286. The HHCBBI index level is calculated by the index provider 220B periodically (e.g., daily) and uploaded in a deliverable file 286 to a server (e.g., an FTP server) for distribution or publishing as shown with arrow 287.

Now, the fourth step of creating and managing a new index can be performed by operations of the system 200. Particularly, an exchange-traded derivative is settled using the new index defined in the file 286 by reference to the index levels of the new index. For the exchange-traded derivative to be “exchange traded,” it preferably is traded all-to-all on a trading venue, which in some cases includes anonymous all-to-all trading on a central limit order book. For the purposes of this explanation and by way of illustration, an exchange 290 (again software running on a networked computing device or computer) retrieves as shown with arrow 287 the HHCBBI index level file 286 daily from an FTP or other server. The exchange 290 then offers a tradeable future settled by reference to the index level of the HHCBBI (the new index).

As mentioned, embodiments disclosed herein can be implemented as one or more computer program products, i.e., one or more modules of computer program instructions encoded on a computer-readable medium for execution by, or to control the operation of, data processing apparatus (processors, cores, etc.). The computer-readable medium can be a machine-readable storage device, a machine-readable storage substrate, a memory device, a composition of matter affecting a machine-readable propagated signal, or a combination of one or more of them. In addition to hardware, code that creates an execution environment for the computer program in question may be provided, e.g., code that constitutes processor firmware, a protocol stack, a database management system, an operating system, or a combination of one or more of them.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

We claim:

1. A system for creating and managing a new index, comprising:
a first server;
a first computer executing code to provide an index provider, wherein the index provider creates an initial benchmark index and generates a benchmark index file stored on the first server that defines a set of investment constituents and index levels for each of the investment constituents;
a second server; and
a second computer executing code to provide an exchange-traded fund (ETF) provider, wherein the ETF provider creates an ETF to track the initial benchmark index and generates an ETF holdings file stored on the second server that defines a set of holdings of the ETF and index levels for each of the holdings and wherein the holdings include a subset of the set of the investment constituents of the initial benchmark index;
wherein the index provider creates a new index by cross referencing the initial benchmark index and the ETF and generates a new index file defining holdings of the new index and index levels for each of the holdings of the new index.

2. The system of claim 1, wherein the index provider periodically publishes the new index file via a server to an exchange and wherein the exchange provides trading of an exchange-traded derivative or future that is settled by the exchange by reference to the index levels of the new index.

3. The system of claim 1, wherein the cross referencing comprises weighting any constituents held in common between holdings information for the ETF and the initial benchmark index.

4. The system of claim 3, wherein the weighting is performed using a notional amount in the ETF subject to constraints to keep composition of the new index within risk parameter boundaries for the initial benchmark index.

5. The system of claim 1, wherein the index provider rebalances the new index monthly on the first business day of a new month with the holdings of the new index being investments present in both the holdings of the ETF and the investment constituents of the initial benchmark index on the last business day of the month prior to the new month.

6. The system of claim 1, wherein the investment constituents in the benchmark index file are selected by the index provider from a corporate bond database based on a set of constituent criteria, whereby the initial benchmark index provides broad coverage and performance attributes of high yield corporate debt from developed countries.

7. The system of claim 6, wherein the index provider rebalances the initial benchmark index monthly on a rebalancing date using the set of constituent criteria to perform a query on the corporate bond database so that the set of the investment constituents includes sub-investment grade bonds issued by corporate issuers from developed countries that are rated by at least one rating service.

8. The system of claim 6, wherein the index provider populates the corporate bond database based on data retrieved from at least one of internal bond reference and pricing data feeds, third party data provider bond feeds, and bond rating feeds.

9. The system of claim 1, wherein the investment constituents comprise bonds, wherein the index provider creates a liquid subset of the set of investment constituents to define an alternate initial benchmark index for use in place of the initial benchmark index by the ETF provider and in the cross referencing to generated the new index, and wherein the creating of the liquid subset includes selecting the investment constituents with a face value greater than a minimum outstanding face value criteria used by the index provider in selecting the investment constituents for the initial benchmark index.

10. The system of claim 1, wherein the ETF provider creates the ETF using representative index sampling on the initial benchmark index and wherein the holdings of the ETF include at least 80 percent of total assets the ETF in a particular industry or group of industries to an extent matching that of the initial benchmark index.

11. A system for creating and managing a new index, comprising:
a data storage device;
an index provider running on a computing device communicatively linked to the data storage device, wherein the index provider creates an initial benchmark index and generates and stores a benchmark index file on the data storage device, the benchmark index file including a listing of investment constituents and index levels for each of the investment constituents; and
an exchange-traded fund (ETF) provider running on a computing device, wherein the ETF provider creates an ETF adapted to track the initial benchmark index and generates an ETF holdings file including a list of holdings of the ETF and index levels for each of the holdings and wherein the holdings include a subset of the set of the investment constituents of the initial benchmark index;
wherein the index provider creates a new index by cross referencing the initial benchmark index and the ETF and generates a new index file defining holdings of the new index and index levels for each of the holdings of the new index,
wherein the index provider periodically publishes the new index file via a server to an exchange,
wherein the exchange provides trading of an exchange-traded derivative or future that is settled by the exchange by reference to the index levels of the new index, and
wherein the cross referencing comprises weighting any constituents held in both the ETF and the initial benchmark index.

12. The system of claim 11, wherein the weighting is performed using a notional amount in the ETF and keeping composition of the new index within risk parameter boundaries for the initial benchmark index.

13. The system of claim 11, wherein the index provider rebalances the new index monthly on the first business day of a new month with the holdings of the new index being investments present in both the holdings of the ETF and the investment constituents of the initial benchmark index on the last business day of the month prior to the new month.

14. The system of claim 11, wherein the investment constituents in the benchmark index file are selected by the index provider from a corporate bond database based on a set of constituent criteria, whereby the initial benchmark index provides broad coverage and performance attributes of high yield corporate debt from developed countries.

15. The system of claim 14, wherein the index provider rebalances the initial benchmark index monthly on a rebalancing date using the set of constituent criteria to perform a query on the corporate bond database so that the set of the investment constituents includes sub-investment grade bonds issued by corporate issuers from developed countries that are rated by at least one rating service.

16. The system of claim 14, wherein the index provider populates the corporate bond database based on data retrieved from at least one of internal bond reference and pricing data feeds, third party data provider bond feeds, and bond rating feeds.

17. The system of claim 11, wherein the investment constituents comprise bonds, wherein the index provider creates a liquid subset of the set of investment constituents to define an alternate initial benchmark index for use in place of the initial benchmark index by the ETF provider and in the cross referencing to generated the new index, and wherein the creating of the liquid subset includes selecting the investment constituents with a face value greater than a minimum outstanding face value criteria used by the index provider in selecting the investment constituents for the initial benchmark index.

18. The system of claim 11, wherein the ETF provider creates the ETF using representative index sampling on the initial benchmark index and wherein the holdings of the ETF include at least 80 percent of total assets the ETF in a particular industry or group of industries to an extent matching that of the initial benchmark index.

19. A method of creating and managing an index, comprising:
implementing an initial benchmark index via a computer by selecting a first set of holdings from a corporate bond database based on a set of constituent criteria, whereby the initial benchmark index provides broad coverage and performance attributes of high yield corporate debt from developed countries;
implementing an exchange-traded fund (ETF) via a computer includes a second set of holdings, differing from the first set of holdings, that are selected to passively track the initial benchmark index;
implementing a new index via a computer by cross referencing the initial benchmark index and the ETF and generating a new index file defining holdings of the new index and index levels for each of the holdings of the new index, wherein the cross referencing comprises weighting any constituents held in both the ETF and the initial benchmark index; and
settling an exchange-traded derivative by reference to index levels of the new index.

20. The method of claim 19, after the implementing of the new index, rebalancing the initial benchmark index monthly on a rebalancing date using a set of constituent criteria to perform a query on the corporate bond database so that the set of holdings in the initial benchmark index includes sub-investment grade bonds issued by corporate issuers from developed countries that are rated by at least one rating service.

21. The method of claim 19, wherein the weighting is performed using a notional amount in the ETF and keeping composition of the new index within risk parameter boundaries for the initial benchmark index.

22. The method of claim 19, wherein the rebalancing is performed monthly on the first business day of a new month with the holdings of the new index being investments present in both the holdings of the ETF and the holdings of the initial benchmark index on the last business day of the month prior to the new month.

23. The method of claim 19, further comprising populating the corporate bond database based on data retrieved from at least one of internal bond reference and pricing data feeds, third party data provider bond feeds, and bond rating feeds.

24. The method of claim 19, wherein the holdings in the initial benchmark index comprise bonds, wherein the method further comprises creating a liquid subset of the set of holdings of the initial benchmark index to define an alternate initial benchmark index for use in place of the initial benchmark index in creating the ETF and in the cross referencing to generate the new index, and wherein the creating of the liquid subset includes selecting the holdings of the initial benchmark index with a face value greater than a minimum outstanding face value criteria used in selecting the holdings for the initial benchmark index.

25. The method of claim 19, wherein implementing of the ETF involves performing representative index sampling on the initial benchmark index and wherein the holdings of the ETF include at least 80 percent of total assets the ETF in a particular industry or group of industries to an extent matching that of the initial benchmark index.
